(19) United States
(12) Patent Application Publication
(10) Pub. No.: US 2025/0119691 A1
(43) Pub. Date: Apr. 10, 2025

(54) Motor Assembly For A Loudspeaker

(71) Applicant: Systematic Audio, LLC, Newton, NC (US)

(72) Inventor: Jacob A. Fuller, Newton, NC (US)

(21) Appl. No.: 18/906,811

(22) Filed: Oct. 4, 2024

Related U.S. Application Data
(60) Provisional application No. 63/589,124, filed on Oct. 10, 2023.

(51) Int. Cl. H04R 9/02; H04R 9/04; H04R 9/06

(52) U.S. Cl. CPC H04R 9/025; H04R 9/046; H04R 9/06

(57) ABSTRACT

A motor assembly for a loud speaker. The motor assembly first comprises a permanent magnet having a central bore. A top plate resides above the permanent magnet while a back plate resides below the permanent magnet. The motor assembly also includes a pole piece. The pole piece extends up from the back plate, into the central bore of the permanent magnet, and above the top plate. The pole piece has an interior surface and an exterior surface, with a central air channel residing along the interior surface and an annular space residing along the exterior surface. The motor assembly is configured such that air is brought up through the central air channel on an upstroke of the voice coil assembly, and air is expelled through the annular space on a downstroke of the voice coil assembly. A method of operating a motor assembly is also provided.

### CROSS REFERENCE TO RELATED APPLICATIONS

This application claims the benefit of U.S. Ser. No. 63/589,124 filed Oct. 10, 2023. That application is entitled “Motor Assembly For A Loudspeaker” and is incorporated herein in its entirety by reference.

### STATEMENT REGARDING FEDERALLY SPONSORED RESEARCH OR DEVELOPMENT

Not applicable.

### BACKGROUND OF THE INVENTION

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### FIELD OF THE INVENTION

The present invention relates to speakers used for the delivery of sound. More specifically, the invention relates to a motor assembly for a loudspeaker, wherein the motor assembly offers a ventilation cap in fluid communication with a pole piece, thereby facilitating the circulation of air around the voice coil.

### Technology in the Field of the Invention

Audio speakers are known as a means for transmitting sound. Audio speakers work by converting electrical energy into mechanical energy, or motion. The mechanical energy is used to compress air and convert the motion into sound energy.

An audio speaker generally comprises a frame, and a motor structure supporting the frame. The frame includes a diaphragm through which sound is emitted, while the motor structure generates three-dimensional pressure waves that act on the diaphragm to produce the sound. Thus, a speaker is essentially a pressure transducer in reverse, that is, it creates pressure (in this case, so-called sound pressure) in response to electrical signals.

The motor structure of the speaker includes a permanent magnet. The permanent magnet may be a series of magnets stacked one on top of the other. The permanent magnet resides between a top plate and a back plate. A so-called pole piece is centrally mounted on the back plate. The pole piece extends up through the permanent magnet.

A so-called voice coil resides within the permanent magnet and around the pole piece. The voice coil comprises a series of windings that interact with a magnetic field created by the permanent magnet. Typically, the windings comprise numerous thin copper wires that are wound around a heat-resistant cylinder. This cylinder may be referred to as a former.

In operation, a current, or electrical signal, is sent through the copper wires. This produces an electric field that interacts with the magnetic field of the permanent magnet. Changes in current cause the voice coil assembly, that is, the former and its windings, to oscillate along a gap between the pole piece and the surrounding permanent magnet. Thus, the voice coil is axially movable relative to the pole piece and the permanent magnet.

The diaphragm is movably suspended along the frame. This is referred to as a “cone and suspension.” A lower end of the diaphragm is coupled to the former. Electrical signals representing sound flow through the voice coil and interact with the magnetic field. Movement of the voice coil causes the coupled diaphragm to move, generating air pressure waves, or sound energy. Thus, the voice coil assembly and diaphragm oscillate together in response to electrical signals to emit sound.

A known problem with large speakers is the build-up of heat along the voice coil. Heat may be generated in two ways. First, resistive heat may build up along the copper windings during use. The DC resistance of the voice coil comprises a major portion of a motor structure's impedance. Thus, a portion of the input power is converted into heat rather than sound.

As the temperature of the voice coil, the former, and the top plate increases, the DC resistance of the windings also increases. This phenomenon is referred to as power compression. The result of power compression is that at higher temperatures, power input is converted into additional heat rather than sound, thereby reducing driver efficiency.

Second, and more significantly, heat is generated by the rapidly-oscillating voice coil around and along the pole piece. This heat emanates to other parts of the speaker, particularly the top plate, and can cause a degradation of acoustic output, or sound quality.

Several designs have been proposed to minimize heat generation. One example is found in U.S. Pat. No. 5,042,072 issued to Button. Button proposed a series of circumferentially spaced, longitudinally extending grooves or channels placed along the pole piece. Each channel extends radially inwardly from the outer surface of the pole piece toward its center. The radial channels are said to direct a flow of air along the voice coil as the air passes in and out of the dust cap cavity. This arrangement is shown in FIG. 1, discussed below. Because the radial channels in the pole piece are oriented parallel to the voice coil along the longitudinal axis of the pole piece, a limited amount of the cooling air actually reaches the voice coil.

U.S. Pat. No. 5,426,707 issued to Wijnker offers a pole piece formed with a central bore, but with a number of transverse openings extending through the wall of the pole piece. The transverse openings are said to create a flow of air from outside of the speaker, into the central bore of the pole piece, and then out of the transverse openings to discharge ports formed in the back plate of the speaker. As an alternative embodiment, Wijnker teaches a flow path into and out of the dust cap cavity. The idea is to encourage air to flow within the magnetic gap between the top plate and the pole piece.

U.S. Pat. No. 6,243,479 issued to Proni also seeks to facilitate the movement of air by providing radial, transverse openings that extend through the pole piece. These are referred to as vent bores. The vent bores provide fluid communication between the central bore of the pole piece and the annular air gap residing between the pole piece and the surrounding former. This arrangement provides for no circulation of air itself along the voice coil.

A need exists for a motor assembly wherein air is forced along the voice coil in response to oscillation of the voice coil itself. A need further exists for a motor assembly wherein air is pumped up into the central air channel of the pole piece during an upstroke of the former, and then pushed down through the annular air gap around the former and out of the motor assembly during the downstroke.

### BRIEF SUMMARY OF THE INVENTION

A motor assembly for a loudspeaker is first provided herein. The motor assembly is designed to provide a circulation of air in response to oscillating movement of the voice coil assembly. Stated another way, an inhale of air takes place during the upstroke of the voice coil assembly, and an exhale of air takes place during the downstroke.

In one aspect, the motor assembly first comprises a permanent magnet. The permanent magnet includes a central bore, forming an annular ring. The permanent magnet is preferably comprised of two or more individual magnets stacked one on top of the other.

The motor assembly also includes a top plate and a back plate. The top plate resides above the permanent magnet while the back plate resides below the permanent magnet. In a preferred embodiment, the permanent magnet comprises a series of at least three magnets stacked one on top of the other between the top plate and the back plate.

In one aspect, the motor assembly further comprises at least one nail. In this instance, the at least three magnets are held in place between the top plate and the back plate by the at least one nail. Each of the nails extends from the top plate, through the magnets, and into the back plate.

The motor assembly also includes a pole piece. The pole piece extends up from the back plate and into the central bore of the permanent magnet. Preferably, the pole piece extends through and above the top plate. The pole piece has an interior surface forming a central air channel, and an exterior surface along the permanent magnet. Optionally, a cylindrical housing resides around the exterior surface, serving to center the permanent magnet around the pole piece. An air annular space is provided along the exterior surface.

The central air channel comprises a lower opening, an upper air channel, and a central channel between the lower opening and the upper air channel. The motor assembly also provides two or more vertical vent channels. The vertical vent channels extend down from the annular space and through the back plate. The vertical vent channels and the upper air channel facilitate air circulation through and around the pole piece.

The motor assembly additionally includes an air flow cap. The air flow cap is positioned over the pole piece. The air flow cap first comprises an upper support ring. The upper support ring includes a plurality of radially disposed openings configured to receive threaded connectors, or bolts. The air flow cap then includes a conical body which extends down from the upper support ring. Vent spaces are reserved along the upper support ring between the radially disposed openings. Beneficially, the vent spaces are in fluid communication with the central air channel.

The motor assembly further comprises a voice coil assembly. The voice coil assembly is disposed around the exterior of the pole piece. Preferably, the voice coil assembly comprises windings made of a conductive wire, and a former supporting the windings. The voice coil assembly resides below the air flow cap and is configured to oscillate along the pole piece in response to electrical signals.

In a preferred arrangement, an air gap is reserved between the pole piece and the surrounding top plate. The air gap resides above and is in fluid communication with the annular air space of the pole piece. The voice coil assembly may oscillate within this air gap.

Also in a preferred arrangement, the top pole piece comprises two or more radially-spaced vent bores. The vent bores provide fluid communication between the inner channel and the air gap between the pole piece and the top plate. The motor assembly is configured such that:
on an upstroke of the voice coil assembly, air is drawn into the central air channel, passes through the upper air channel, and then through the vent spaces of the air flow cap; and
on a downstroke of the voice coil assembly, air is pushed out from below the diaphragm, into the air gap between the pole piece and the surrounding top plate, into the annular space between the pole piece and the surrounding permanent magnet, and then through the vertical vent channels.

A method of operating a motor assembly is also provided herein. The motor assembly is associated with a speaker device, such as a loudspeaker. Preferably, the speaker device is a woofer.

In one embodiment, the method first comprises providing a motor assembly. The motor assembly may be configured in accordance with the motor assembly described above, in its various embodiments. In this respect, the motor assembly may comprise:
a permanent magnet having a central bore therein, forming an annular ring;
a top plate above the permanent magnet;
a back plate below the permanent magnet;
a pole piece extending up from the back plate into the central bore of the permanent magnet, with the pole piece having an interior surface and an exterior surface, wherein a central air channel resides along the interior surface, and an annular space is preserved along the exterior surface;
two or more vertical vent channels extending down from the annular space and through the back plate;
an air flow cap positioned over the pole piece, wherein the air flow cap comprises two or more vent spaces in fluid communication with the central air channel; and
a voice coil assembly disposed within an air gap formed between the pole piece and the surrounding top plate.

As noted above, the top plate resides above the permanent magnet while the back plate resides below the permanent magnet. In a preferred embodiment, the permanent magnet comprises a series of at least three magnets stacked one on top of the other between the top plate and the back plate. The central air channel comprises a lower opening proximate the back plate, and an upper channel proximate the air flow cap.

As also noted above, the pole piece has an interior surface and an exterior housing. A central air channel resides along the interior surface while the permanent magnet resides around the exterior housing. An annular space is provided adjacent to and within the exterior housing, that is, between the pole piece and the surrounding permanent magnet.

As also noted above, the air flow cap first comprises an upper support ring. The upper support ring includes a plurality of radially disposed openings configured to receive threaded connectors, or bolts. The air flow cap then includes a conical body. The conical body extends down from the upper support ring towards the central air channel of the pole piece. Vent spaces are reserved along the upper support ring between the radially disposed openings. Beneficially, the vent spaces are in fluid communication with the central air channel.

The method also includes delivering electrical signals to the voice coil assembly. This causes the voice coil assembly to oscillate at least partially along the exterior housing of the pole piece.

An air gap is reserved between the pole piece and the surrounding top plate. The air gap resides above and is in fluid communication with the annular air space of the pole piece. Oscillation of the voice coil assembly causes air to circulate. Specifically, an upstroke of the voice coil assembly draws air in through the lower opening, into the central air channel, into the upper opening, and through the vent spaces of the air flow cap. A downstroke of the voice coil assembly pushes air out from below the diaphragm, into the annular air gap between the pole piece and the surrounding top plate, into the annular space within the exterior housing, and then through the vertical vent channels. Thus, an inhale and exhale action is created for the motor assembly.

In one aspect, the pole piece further comprises two or more radially-spaced vent bores extending from the central air channel to the annular air gap. In this instance, oscillation of the voice coil assembly further causes air to circulate from the central air channel directly into the annular air gap.

### DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a known speaker device having a frame and a motor structure, or drive.

FIG. 2A is a first perspective view of a motor assembly of the present invention, in one embodiment. The motor assembly serves as a driver for a speaker device.

FIG. 2B is a second perspective view of the motor assembly of FIG. 2A. FIG. 2B is taken from a view that is generally opposite the view of FIG. 2A.

FIG. 3 is a perspective view of an air flow cap, which is part of the motor assembly of FIGS. 2A and 2B. The air flow cap is configured and dimensioned to reside over the pole piece.

FIG. 4A is a cross-sectional view of the motor assembly of the present invention, in one illustrative arrangement. Of interest, the air flow cap has been placed over the pole piece.

FIG. 4B is a second cross-sectional view of the motor assembly of FIG. 4A. Here, the voice coil has moved up along the pole piece. Air is being pulled up into a central air channel, and out vent spaces provided in the air flow cap.

FIG. 4C is a third cross-sectional view of the motor assembly of FIG. 4A. Here, the voice coil has oscillated into a downward position along the pole piece. Air is being pushed down through an annular air gap around the pole piece, through an annular space along the pole piece, and down through vertical vent channels.

### DETAILED DESCRIPTION OF SELECTED SPECIFIC EMBODIMENTS

The present invention may be understood more readily by reference to the following detailed description taken in connection with the accompanying figures, which form a part of this disclosure. It is to be understood that this invention is not limited to the specific devices, methods or parameters described or shown herein, and that the terminology used herein is for the purpose of describing particular embodiments. Such embodiments are provided by way of example only and are not intended to be limiting of the invention, which is set forth in the appended claims.

Also, as used in the specification including the appended claims, the singular forms “a,” “an,” and “the” include the plural, and references to a particular numerical value include at least that particular value, unless the context clearly dictates otherwise.

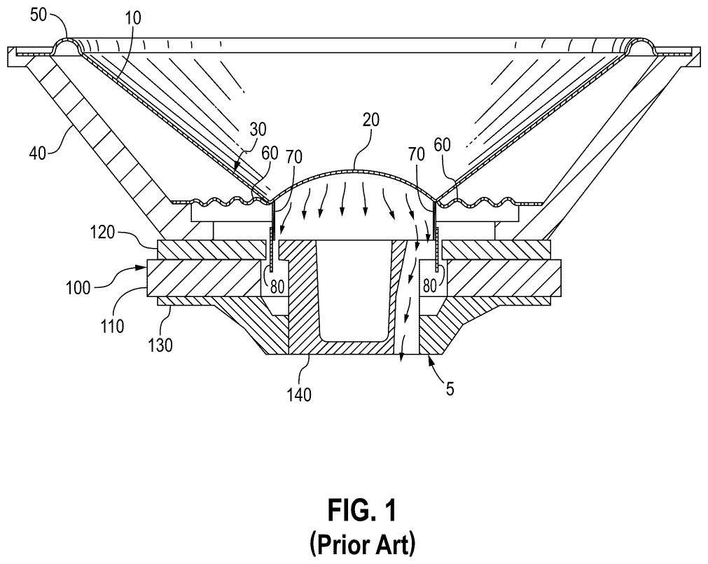

FIG. 1 presents a known speaker of the permanent magnet type. Specifically, FIG. 1 shows a conventional electrodynamic loudspeaker 5. This drawing is taken from FIG. 1 of U.S. Pat. No. 5,042,072 issued in 1991 to Harman International Industries, Inc.

The speaker 5 consists of a cone 10 which is attached through adhesive means to a dome 20. This forms a diaphragm 30. The diaphragm 30 may be constructed from a stiff but well-damped material such as paper. The diaphragm 30 is connected to a speaker frame 40. The speaker frame 40 is constructed of a stiff, anti-vibrational material such as aluminum. Connection may be by means of an upper half roll compliance 50, which may be made from a flexible and fatigue resistant material. Examples include urethane foam, butyl rubber or a phenolic impregnated cloth.

On its lower portion, the speaker frame 40 is connected to the intersection of the cone 10 and the dome 20 by a so-called spider 60. The spider 60 is made from a material similar in properties to the material of the upper half roll compliance 50. By this connection, the diaphragm 30 is prevented from radial movement and, thus, is constrained to axial movement.

On the lower portion of the loudspeaker 5 is the permanent magnet 100. The permanent magnet 100 comprises at least one magnet 110, which resides between a top plate 120 and a back plate 130. Both of these plates 120, 130 are constructed from a material capable of carrying magnetic flux such as steel. Also on the lower half of the loudspeaker 5 is a pole piece 140. The pole piece 140 is also constructed from a material capable of carrying magnetic flux such as cast iron. The pole piece 140 is connected to the back plate 130.

At the point of intersection of the cone 10 and the dome 20 is a former 70. The former 70 is made of high temperature resistant plastic which is also attached to the cone 20. A conductive voice coil 80 is attached to the former 70, such as by an adhesive. When current is passed through the voice coil 80, a magnetic field is produced by the permanent magnet 100. The magnetic field causes the voice coil 80 and connected former 70 to oscillate in accordance with the electrical signal, and drive the diaphragm 30, producing sound.

At the top of the pole piece 140 is a magnetic gap. The gap exists between the pole piece 140 and the surrounding top plate 120. The former 70 and connected magnetic coil 80 reside at least partially within, or extend through, this gap. This structure allows an axial movement of the coil 80 in the magnetic gap.

It can be seen in FIG. 1 that a vertical channel is placed between the pole piece 140 and the surrounding top plate 120 and back plate 130. Arrows indicate a potential flow of air from below the dome 20 out of the motor. As shown, this air flow is not circulated as it only flows in one direction.

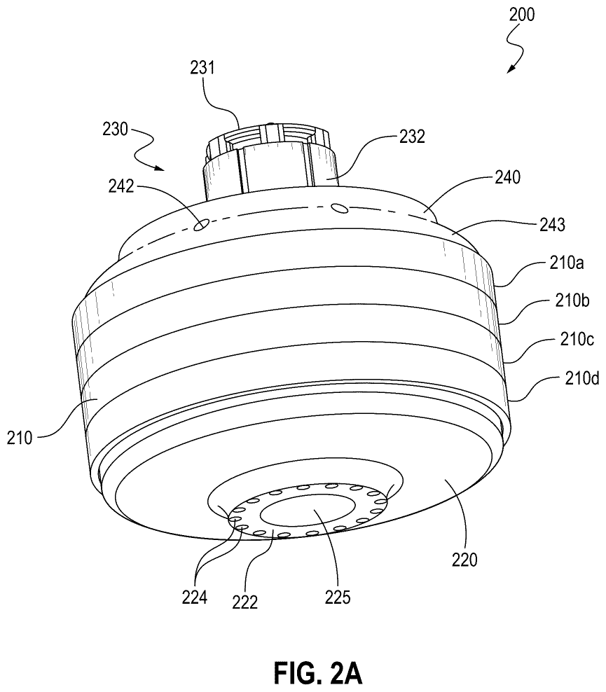

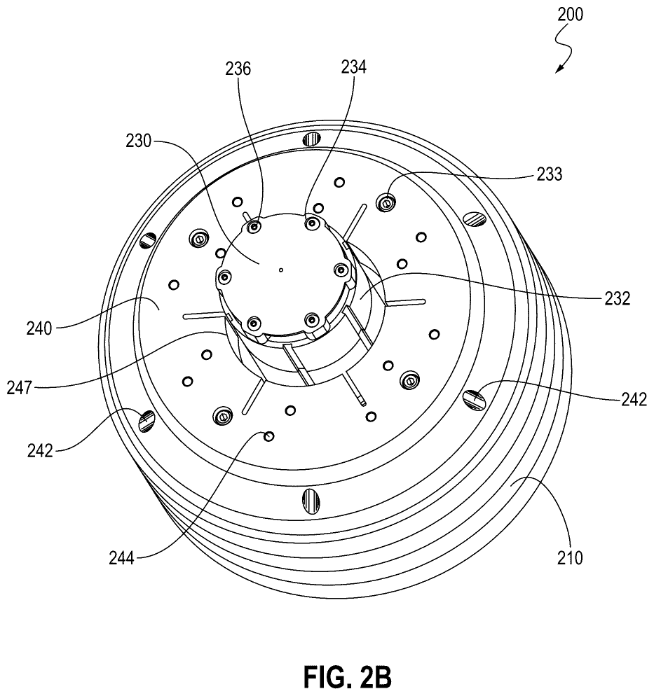

FIG. 2A is a perspective view of a motor assembly 200 of the present invention, in one embodiment. The motor assembly 200 is used as a so-called driver for a speaker. The speaker is preferably a woofer. Those of ordinary skill in the art will understand that a woofer is a technical term for a bass speaker, that is, a loudspeaker designed to produce low-frequency sounds. Such low frequency sounds typically range from 50 Hz up to 1,000 Hz.

Woofers have the largest drivers and are usually at least five inches in diameter. However, the motor assembly 200 is not limited to use in woofers but may be used for any speaker device.

FIG. 2B is a second perspective view of the motor assembly 200 of FIG. 2A.

Here, the motor assembly 200 is shown from a view that is generally opposite the view of FIG. 2A. The motor assembly 200 will be described with reference to FIGS. 2A and 2B together.

The motor assembly 200 first comprises a permanent magnet 210. In this arrangement, the permanent magnet 210 comprises four separate magnets 210a, 210b, 210c, 210d, stacked one on top of the other. However, it is understood that a loudspeaker may have a different number of magnets 210 used to create a magnetic field.

At the base of the motor assembly 200 is a back plate 220. The back plate 220 has a circular profile. Concentrically within the back plate 220 is a flange 222. A plurality of through-openings 224 are equi-radially spaced about the flange 222. The through-openings 224 serve as vertical vent channels. As will be discussed more fully below, the vertical vent channels 224 serve as an egress for air being circulated out of the motor assembly 200.

Residing centrally within the flange 222 is a central air channel 225. During operation of a speaker, the central air channel 225 receives air into the motor assembly 200 for circulation.

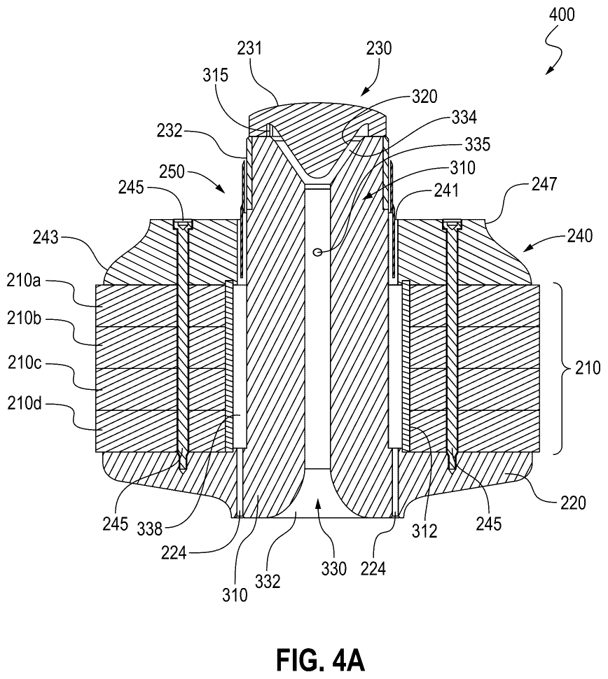

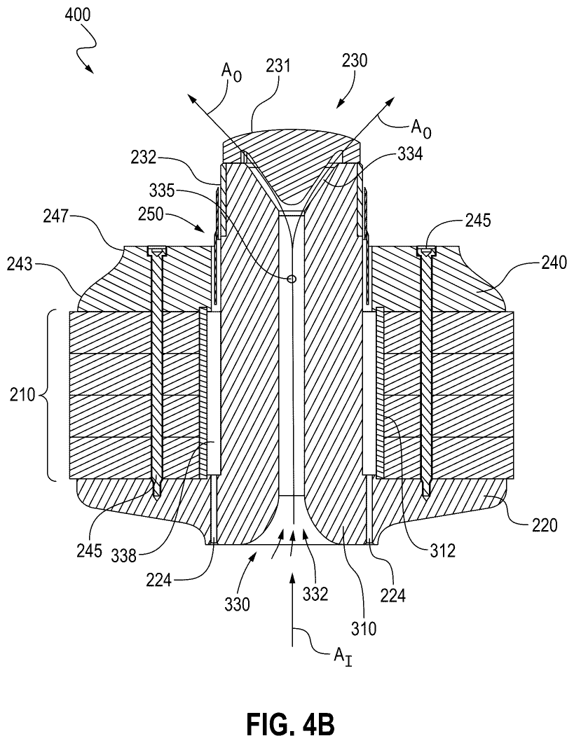

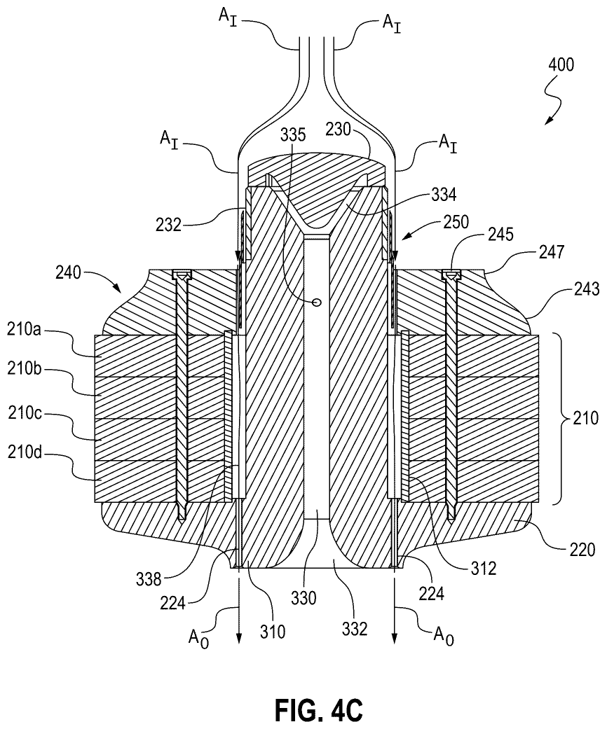

Opposite the back plate 220 and above the magnets 210 is a top plate 240. Some researchers in the industry may refer to the top plate 240 as a washer. The top plate 240 is typically fabricated from steel. The top plate 240 serves to secure the permanent magnet 210 onto the back plate 220. The pole piece (seen at 310 in FIG. 4A) will extend up from the back plate 220 and through the top plate 240.

In the arrangement of FIGS. 2A and 2B, the top plate 240 has a frusto-conical profile. A base 243 of the top plate 240 resides on an upper end of the permanent magnet 210, while an upper portion 247 of the top plate 240 supports the cone and suspension of the speaker. An exemplary arrangement for a cone and suspension (including the diaphragm) is shown in FIG. 1 of U.S. Pat. No. 7,715,584, the entirety of the patent being incorporated herein by reference.

The top plate 240 includes a series of through-openings 242. These through-openings serve as vent holes. The vent holes 242 at least partially serve a heat dissipation function.

As seen in FIG. 2B, the top plate 240 also includes a series of radially-disposed holes at 244. These are simply bolt holes 244 used for attaching the frame. Some may refer to the frame and its diaphragm as a basket.

Extending up from the top plate 240 is an upper portion 232 of the pole piece (numbered as 310 in FIGS. 4A through 4C.) Residing on and secured to the upper portion 232 is an air flow cap 230. The air flow cap 230 receives air generated from oscillation of the voice coil assembly (shown at 250 in FIGS. 4A through 4C), and directs it against an under surface of the diaphragm (such as diaphragm 10 and cone 20 of FIG. 1). It is understood that the voice coil assembly 250 will include a series of electrically conductive wires (referred to as windings), secured to a cylinder called a former. The windings and connected former will oscillate along the pole piece 310 in response to electrical signals.

The upper portion 232 of the pole piece 310 may be referred to as a shorting sleeve. The shorting sleeve 232 defines a cylindrical body that resides at the upper end of the pole piece 310. The shorting sleeve 232 reduces inductance on the upward stroke of the voice coil assembly 250.

The air flow cap 230 connects to the shorting sleeve 232 above the pole piece 310 using bolts 236. The air flow cap 230 includes a series of bolt holes 234 that receive the respective bolts 236. The air flow cap 230 distributes pulses of air radially from the shorting sleeve 232.

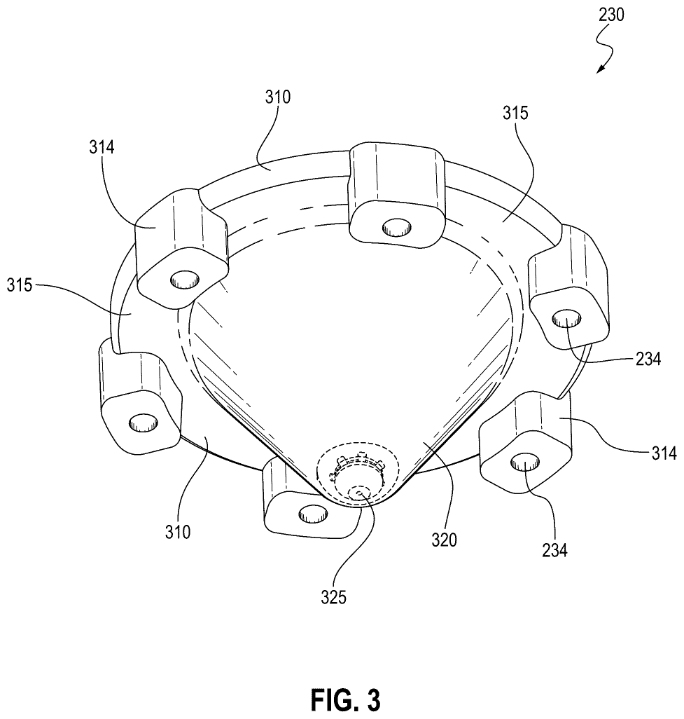

FIG. 3 is a perspective view of the air flow cap 230, in one arrangement. In this view, the air flow cap 230 is seen from an under-surface 320. The air flow cap 230 comprises a ring 310. The ring 310 serves as an upper support member. A series of support columns 314 are equi-distantly placed around the ring 310. Each support column 314 includes a through-opening that forms the bolt holes 234.

The under-surface 320 has a conical profile. A soft tip 325 extends below the support columns 314 at a lowest end of the under-surface 320. The soft tip 325 and the conical profile of the under-surface 320 serve to deflect air upwards towards the support ring 310.

It is observed that a series of vent spaces 315 are preserved around the upper support ring 310. Particularly, the vent spaces 315 reside between the support columns 314. The vent spaces 315 direct air away from the motor assembly 200 and towards the so-called spider (such as lower suspension 18 of FIG. 1 of U.S. Pat. No. 7,715,584 referenced above). This facilitates the deflection function of the air flow cap 230.

FIG. 4A is a cross-sectional view of a motor assembly 400 of the present invention, in one illustrative arrangement. Here, the permanent magnet 210 is seen residing between the back plate 220 and the top plate 240. Two nails 245 are visible in this cross-sectional view. The nails 245 are placed into respective openings along the top plate 240. The nails 245 extend down through the individual magnets 210a, 210b, 210c, 210d, and then into the back plate 220. This keeps the individual magnets 210a, 210b, 210c, 210d in place.

The pole piece 310 is seen extending up from the back plate 220. The pole piece 310 resides within the permanent magnet 210. The pole piece 310 has an exterior housing 312 that abuts the surrounding individual magnets 210a, 210b, 210c, 210d. The exterior housing 312 serves as an outer wall for the pole piece 310 and also serves to centralize the individual magnets 210a, 210b, 210c, 210d. Note that in this arrangement, the housing 312 only extends up to the bottom of the top plate 240.

The pole piece 310 also has an interior surface. The interior surface defines a central air channel 330. The central air channel 330 has a lower end 332 which generally serves as an air intake end. Additionally, the central air channel 330 has an upper end 334 which generally serves as an air release end.

In FIG. 4A, the air flow cap 230 is seen over the pole piece 310. The air flow cap 230 has an upper concave surface 231. Also visible in FIG. 4A is the conical under-surface 320. Vent spaces 315 are seen along the air flow cap 230. The vent spaces 315 are in fluid communication with the upper air channel 334. Thus, air flowing up through the air channel 330 is released into the vent spaces 315 and under the spider 60.

The pole piece 310 extends up above the top plate 240. An annular air gap 241 is preserved between the pole piece 310 and the surrounding top plate 240. At least a portion of the air that is exhaled through the vent spaces 315 will be circulated back down into the air gap 241.

In the arrangement of FIG. 4A, two or more radially-spaced vent bores 335 are provided in the pole piece 330. These optional vent bores 335 extend from the inner air channel 330 and out to the annular air gap 341. The vent bores 335 provide an additional path for the circulation of air for cooling the voice coil assembly 250 and top plate 240 during oscillation.

Also visible in FIG. 4A is an annular air space 338. The annular air space 338 resides along the exterior housing 312 of the pole piece 330. The annular air space 338 resides below the air gap 341. Air that enters the air gap 341 (either from the vent spaces 315 or vent bores 335) will be distributed to the annular air space 338. It is understood that the cylindrical housing 312 is optional and that the annular air space 338 may simply be the space between the pole piece 310 and the surrounding permanent magnet 210.

Finally, the motor assembly 400 of FIG. 4A includes two or more vertical vent channels 224. The vertical vent channels 224 reside below the annular air space 338, and extend through the back plate 220. Air that enters the annular air gap 341 (either from the vent spaces 315 or vent bores 335) is distributed to the annular air space 338, and then is exhaled from the motor assembly 400 through the vertical vent channels 224.

FIG. 4B is a second cross-sectional view of the motor assembly 400 of FIG. 4A. Here, the voice coil assembly 250 has moved up along the pole piece 310. This is in response to electrical signals applied to the voice coil assembly 250. Movement of the voice coil assembly 250 upward will draw air into the lower opening 332 of the air channel 330. Air will then flow through the upper air channel 334 and out of the vent spaces 315 as indicated by the direction of Arrows A₁ and A₀. This air will flow at high velocity towards the so-called spider (such as lower suspension 18 of FIG. 1 of U.S. Pat. No. 7,715,584 referenced above) on the back side of the windings.

It is observed that some air may incidentally be pulled into the motor assembly 400 through the vertical vent channels 224. However, because the central air channel 330 of the pole piece 310 is larger and more aerodynamic than the vertical vent channels 224, much more air will be inhaled through the central channel 330.

FIG. 4C is a third cross-sectional view of the motor assembly 400 of FIG. 4A. Here, the voice coil 250 has oscillated into a downward position along the pole piece 310. This too is in response to electrical signals applied to the voice coil assembly 250. Movement of the voice coil assembly 250 downward (referred to herein as a downstroke) will push air residing below the spider downward into the annular air gap 341, then through the annular air space 338, into the vertical vent channels 224, and out of the motor assembly 400. This is indicated by the direction of Arrows A₁ and A₀.

It is observed in FIG. 4C that the air flows around the conical, or domed, shape 231 of the air flow cap 230. The unique domed shape 231 directs air towards the air gap 341 and away from the vent spaces 315. This causes the majority of the circulated air to flow across the windings of the voice coil assembly 250, causing the motor assembly to cool the windings and to operate more efficiently.

It is understood that in operation, the voice coil assembly 250 of a speaker will oscillate tens if not hundreds of times a second. The length and speed of each stroke of the voice coil assembly 250 will vary depending on the electrical signals and the distribution of the windings around the former. However, it is believed that regardless of the length and speed of the strokes, this oscillating movement of the voice coil assembly 250 will produce an inhale-and-exhale movement of air, causing a novel cooling of the windings.

It is also understood that in many motor assemblies in the audio industry, the pole piece and the back plate are one integral body. Thus, in the present application when it is said that the two or more vertical vent channels extend down through the back plate, this includes any arrangement where the vertical vent channels extend down through the pole piece.

A method of operating a motor assembly is also provided herein. The motor assembly is associated with a speaker device, such as a loud speaker or a woofer.

In one embodiment, the method first comprises providing a motor assembly. The motor assembly may be configured in accordance with the motor assembly described above, in its various embodiments. In this respect, the motor assembly may comprise:
a permanent magnet having a central bore therein;
a top plate above the permanent magnet;
a back plate below the permanent magnet;
a pole piece extending up from the back plate into the central bore of the permanent magnet, with the pole piece having an interior surface forming a central air channel, and an exterior surface forming an annular space;
two or more vertical vent channels extending down from the annular space and through the back plate;
an air flow cap positioned over the pole piece, wherein the air flow cap comprises two or more vent spaces in fluid communication with the central air channel;
an annular air gap residing between an upper end of the pole piece and the surrounding top plate; and
a voice coil assembly disposed within the annular air gap.

As noted above, the top plate resides above the permanent magnet while the back plate resides below the permanent magnet. In a preferred embodiment, the permanent magnet comprises a series of at least three magnets stacked one on top of the other between the top plate and the back plate. The magnets are placed around the pole piece, forming the annular air space.

As also noted above, the pole piece has an interior surface and an exterior surface. A central air channel resides along the interior surface while the permanent magnet resides around the exterior surface. The annular space is provided adjacent the exterior surface. At the same time, the central air channel comprises a lower opening, an upper air channel, and a central channel between the lower opening and the upper channel.

As also noted above, the air flow cap first comprises an upper support ring. The upper support ring includes a plurality of radially disposed openings configured to receive threaded connectors, or bolts. The air flow cap then includes a conical body. The conical body extends down from the upper support ring. Vent spaces are reserved along the upper support ring between the radially disposed openings. Beneficially, the vent spaces are in fluid communication with the central air channel by means of the upper channel.

The method also includes delivering electrical signals to the voice coil assembly. The voice coil assembly is configured to oscillate in response to electrical signals indicative of, or driving, sound. The voice coil assembly oscillates at least partially along the exterior surface of the pole piece.

An annular air gap is reserved between the pole piece and the surrounding top plate. The air gap resides above and is in fluid communication with the annular air space of the pole piece. Oscillation of the voice coil assembly also causes air to circulate from the lower opening, through the central air channel, into the upper opening, through the vent spaces, back down the annular air gap, through the annular air space, and down through the vertical vent channels.

In one aspect, the pole piece further comprises two or more radially-spaced vent bores extending from the inner channel to the annular air gap. In this instance, oscillation of the voice coil assembly further causes air to circulate from the central air channel to the air gap.

The motor assembly is configured such that:
on an upstroke of the voice coil assembly, air is drawn into the central air channel, passes through the upper air channel, and then through the vent spaces of the air flow cap; and
on a downstroke of the voice coil assembly, air is pushed out from below the diaphragm, into the annular air gap between the pole piece and the surrounding top plate, into the annular air space along the exterior surface, and then through the vertical vent channels.

During both the upstroke and the downstroke, air may pass through the vent bores, further increasing air circulation proximate the voice coil assembly.

Optionally, a cylindrical support wall (not shown) resides around the permanent magnet. Optionally, a cylindrical housing resides around the exterior surface of the pole piece, serving to center the permanent magnet around the pole piece

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application.

In the claims which follow, the word “comprising” is used in its inclusive sense and does not exclude other elements being present. Each one of the individual features described here may be used in one or more embodiments and is not, by virtue only of being described here, to be construed as essential to all embodiments as defined by the claims.

I claim:

1. A motor assembly for a loudspeaker, comprising:
a permanent magnet having a central bore therein;
a top plate above the permanent magnet;
a back plate below the permanent magnet;
a pole piece extending up from the back plate into the central bore of the permanent magnet and having an interior surface and an exterior surface, wherein the interior surface defines a central air channel, and wherein the exterior surface defines an annular space between the pole piece and the surrounding permanent magnet;
two or more vertical vent channels extending down from the annular space and through the back plate;
an air flow cap positioned over the pole piece, wherein the air flow cap comprises two or more vent spaces in fluid communication with the central air channel;
an annular air gap formed between the pole piece and the surrounding top plate; and
a voice coil assembly disposed within the annular air gap;
and wherein the pole piece extends above the top plate.

2. The motor assembly of claim 1, wherein the voice coil assembly comprises:
windings made of a conductive wire; and
a former supporting the windings;
and wherein the voice coil assembly resides below the air flow cap and is configured to oscillate along the annular air gap in response to electrical signals.

3. The motor assembly of claim 2, wherein the air flow cap further comprises:
an upper support ring;
a plurality of radially disposed openings around the upper support ring configured to receive connectors; and
a conical body extending down from the upper support ring;
and wherein the vent spaces are in fluid communication with the central air channel.

4. The motor assembly of claim 3, wherein:
the permanent magnet comprises a series of at least three magnets stacked one on top of the other between the top plate and the back plate; and
the at least three magnets are held in place between the top plate and the back plate by at least one nail that extends from the top plate, through the at least three magnets, and into the back plate.

5. The motor assembly of claim 3, wherein:
the central air channel comprises a lower opening, an upper channel, and a central channel between the lower opening and the upper channel; and
the annular air gap resides above and is in fluid communication with the annular space of the pole piece.

6. The motor assembly of claim 5, wherein the pole piece further comprises two or more radially-spaced vent bores extending from the central channel to the annular air gap.

7. The motor assembly of claim 5, wherein the air flow cap comprises an upper surface having a domed profile.

8. The motor assembly of claim 5, wherein:
a diaphragm resides above the air flow cap;
on an upstroke of the voice coil assembly, air is drawn into the central air channel, passes through the upper channel, and then through the vent spaces of the air flow cap to engage the diaphragm; and
on a downstroke of the voice coil assembly, air is pushed out from below the diaphragm, into the annular air gap between the pole piece and the surrounding top plate, into the annular space around the exterior surface, and then through the vertical vent channels.

9. The motor assembly of claim 8, further comprising:
a cylindrical housing residing around the exterior surface of the pole piece, serving to center the permanent magnet around the pole piece.

10. A method of operating a motor assembly for a speaker device, comprising:
providing a motor assembly, comprising:
a permanent magnet having a central bore therein;
a top plate above the permanent magnet;
a back plate below the permanent magnet;
a pole piece extending up from the back plate into the central bore of the permanent magnet and having an interior surface and an exterior surface, wherein the interior surface defines a central air channel, and wherein the exterior surface defines an annular space;
two or more vertical vent channels extending down from the annular space and through the back plate; and
an air flow cap positioned over the pole piece, wherein the air flow cap comprises two or more vent spaces in fluid communication with the central air channel;
an annular air gap formed between the exterior surface of the pole piece and the top plate; and
a voice coil assembly disposed within the annular air gap; and
delivering electrical signals to the voice coil assembly, thereby causing the voice coil assembly to oscillate at least partially within the annular air gap.

11. The method of claim 10, wherein:
the permanent magnet is disposed around the exterior surface of the pole piece, forming the annular space;
the pole piece extends above the top plate; and
the voice coil assembly comprises windings made of a conductive wire, and a former supporting the windings.

12. The method of claim 11, wherein the air flow cap comprises:
an upper support ring;
a plurality of radially disposed openings around the upper support ring configured to receive connectors; and
a conical body extending down from the upper support ring;
and wherein the vent spaces are in fluid communication with the central air channel.

13. The method of claim 12, wherein:
the central air channel comprises a lower opening, an upper channel, and a central channel between the lower opening and the upper channel;
the annular air gap resides above and is in fluid communication with the annular space of the pole piece; and
oscillation of the voice coil assembly causes air to circulate from the lower opening, through the central air channel, into the upper opening, through the vent spaces, back down the annular air gap, through the annular space, and down through the vertical vent channels.

14. The method of claim 13, wherein:
the permanent magnet comprises a series of at least three magnets stacked one on top of the other between the top plate and the back plate; and
the at least three magnets are held in place between the top plate and the back plate by at least one nail that extends from the top plate, through the at least three magnets, and into the back plate.

15. The method of claim 13, wherein the speaker device is a woofer.

16. The method of claim 13, wherein:
the pole piece further comprises two or more radially-spaced vent bores extending from the inner channel to the annular air gap; and
oscillation of the voice coil assembly further causes air to circulate from the central air channel to the annular air gap.

17. The method of claim 13, wherein:
a diaphragm resides above the air flow cap;
on an upstroke of the voice coil assembly, air is drawn into the central air channel, passes through the upper channel, and then through the vent spaces of the air flow cap; and
on a downstroke of the voice coil assembly, air is pushed out from below the diaphragm, into the annular air gap between the pole piece and the surrounding top plate, into the annular space within the exterior housing, and then through the vertical vent channels.

18. The method of claim 17, wherein the motor assembly further comprises a cylindrical housing residing around the exterior surface of the pole piece, serving to center the permanent magnet around the pole piece.
